(19) United States
(12) Patent Application Publication
(10) Pub. No.: US 2013/0204413 A1
(43) Pub. Date: Aug. 8, 2013

(54) Audio Hyperlinking

(71) Applicant: Samir Gehani, Cupertino, CA (US)

(72) Inventor: Samir Gehani, Cupertino, CA (US)

(73) Assignee: APPLE INC., Cupertino, CA (US)

(21) Appl. No.: 13/368,129

(22) Filed: Feb. 7, 2012

(51) Int. Cl. G06F 19/00

(52) U.S. Cl. 700/94

(57) ABSTRACT

Hyperlinks within an audio stream provide a way for a listener to access linked resources. An audio hyperlink encoded in an audio stream indicates the presence of an audio hyperlink in the audio stream, as well as providing information for traversing the hyperlink to the linked resource. The hyperlink may be conditionally traversed upon a user interaction or automatically upon detection in the audio stream, possibly pausing the audio stream containing the hyperlink during the traversal of the hyperlink and resuming the audio stream if the audio stream is returned to from the linked material. The linked material may be other audio content, but may also be any other type of desired content that may be accessible by the system processing the audio stream.

### BACKGROUND

This disclosure relates generally to the field of processing of multimedia content. More particularly, but not by way of limitation, it relates to a technique for allowing audio content to contain links to other content.

The first known discussion of linking pages of information is generally considered to have appeared in essays by Vannevar Bush in the first half of the 20^{th} century. The term hyperlink as a reference to data that can be followed, either by user interaction or automatically, is generally considered to have been coined by Ted Nelson for his Project Xanadu around 1964. Providing hyperlinks in textual documents has proven a very valuable capability that has allowed many benefits. Hyperlinks are a ubiquitous feature of web pages on the World Wide Web, but may also appear in numerous other technologies, including help systems, word processing documents, spreadsheets, etc. But hyperlinking has typically been limited to textual documents, including web pages, and providing a way to allow hyperlinking of non-textual material would be useful. For example, many podcast programs identify other resources that might be of interest to the listener, such as other podcasts or web material, there is currently no way for a podcast to provide a hyperlink to such other resources in the audio content of the podcast.

### SUMMARY

Hyperlinks within an audio stream provide a way for a listener to access linked resources. An audio hyperlink encoded in an audio stream indicates the presence of an audio hyperlink in the audio stream, as well as providing information for traversing the hyperlink to the linked resource. The hyperlink may be conditionally traversed upon a user interaction or automatically upon detection in the audio stream, possibly pausing the audio stream containing the hyperlink during the traversal of the hyperlink and resuming the audio stream if the audio stream is returned to from the linked material. The linked material may be other audio content, but may also be any other type of desired content that may be accessible by the system processing the audio stream.

In one embodiment, a non-transitory computer readable medium is disclosed. The medium includes computer code to cause an audio stream to playback on an electronic device; computer code to traverse a hyperlink encoded with the audio stream to a destination object during playback of the audio stream; and computer code to perform an activity corresponding to the destination object.

In another embodiment, a non-transitory computer readable medium is disclosed. The medium includes computer code to receive a request to insert a hyperlink in an audio stream; computer code to generate a hyperlink indicator responsive to the request; computer code to generate a hyperlink information; and computer code to encode the hyperlink indicator with the audio stream.

In yet another embodiment, a non-transitory storage medium is disclosed. The medium has stored thereon encoded audio information, wherein the audio information includes a hyperlink indicator that indicates that a hyperlink is encoded with the audio information; and a hyperlink information element that provides information describing the hyperlink.

In yet another embodiment, an apparatus is disclosed. The apparatus includes a programmable control device; a memory coupled to the programmable control device, wherein instructions are stored in the memory, the instructions causing the programmable control device to recognize a hyperlink indicator encoded with an audio stream processed by the programmable control device; decode a hyperlink information associated with the hyperlink indicator; and traverse the hyperlink described by the hyperlink information.

In yet another embodiment, a method of inserting an audio hyperlink into an audio stream is disclosed. The method includes encoding a hyperlink indicator with the audio stream; and encoding a hyperlink information with the audio stream with the hyperlink indicator, wherein the hyperlink information provides information for a programmable control device to access a destination object.

In yet another embodiment, a method of using a hyperlink encoded into an audio stream is disclosed. The method includes playing the audio stream on an electronic device; decoding a hyperlink information associated with a hyperlink indicator encoded with the audio stream; accessing and performing a destination object identified by the hyperlink information; suspending playing the audio stream upon performing accessing the destination object; and resuming playing the audio stream upon completion of performing the destination object.

### BRIEF DESCRIPTION OF THE DRAWINGS

FIG. 1 is a pair of audio waveforms, illustrating linking from one audio stream to another according to one embodiment.

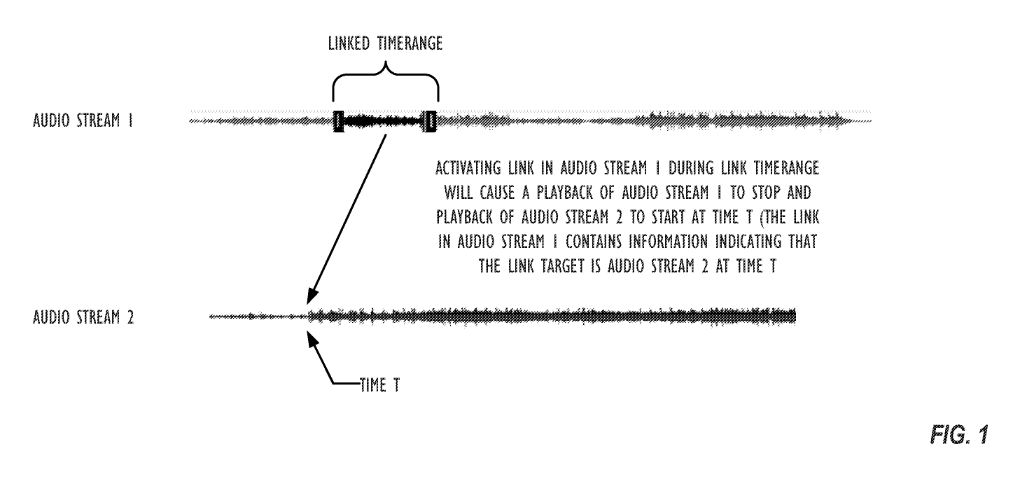

FIG. 2 is a flowchart illustrating a technique for creating an audio hyperlink according to one embodiment.

FIG. 3 is a flowchart illustrating a technique for traversing an audio hyperlink during playback of an audio stream according to one embodiment.

FIG. 4 is a block diagram illustrating an electronic device in which the techniques of FIGS. 2 and 3 may be implemented.

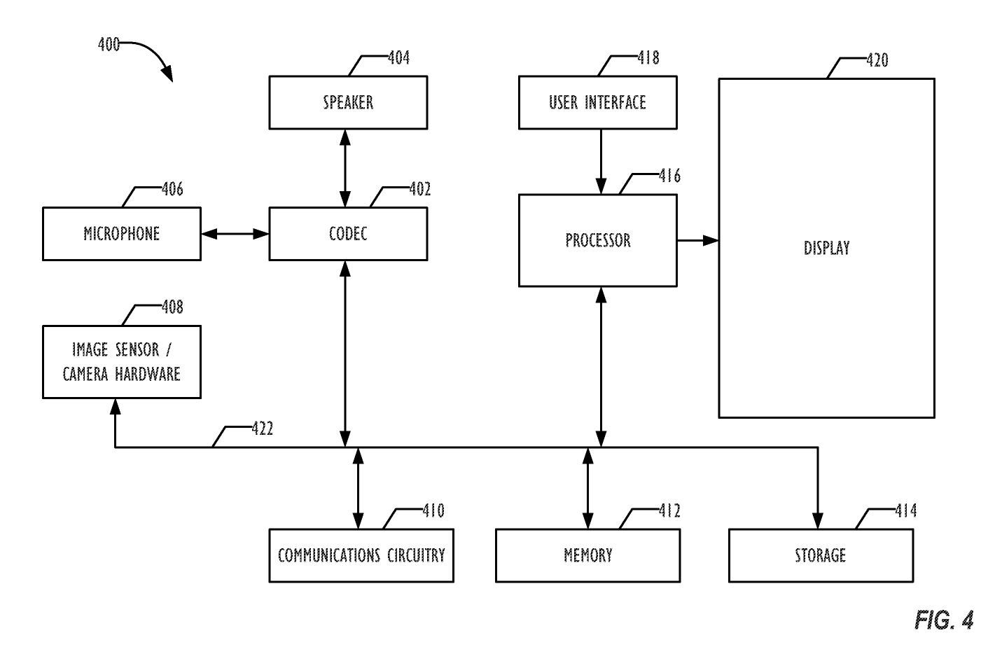

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

By encoding audio hyperlinks into audio streams, audio streams can take advantage of the ability to link between resources currently available in web browsers and other text-based systems. A system employing audio hyperlinks can allow users to jump between the audio stream and other resources. As with hypertext systems, an audio hyperlinking system employs hyperlink information encoded into the audio stream that can be used by an electronic device to identify, access, and perform linked resources.

In one embodiment, the audio hyperlink may be stored as metadata in the audio file format rather than interleaved with compressed (or uncompressed) audio sample data.

### Audio Streams

As used herein, an audio stream is defined as a sequence of encoded audio information that may be played by an electronic device. The audio stream may be provided as a file in a file system in the electronic device or may be provided as a stream of data received from an audio source that is communicatively connected to the electronic device, without regard to the communications techniques used to provide the audio stream to the electronic device. Audio streams may be stored on optical media and electronic media, in addition to being communicated from one device to another.

There are many ways of encoding audio information into an audio stream, and any encoding technique may be used as desired. Similarly, there are many ways of decoding audio information encoded as an audio stream, and any decoding technique may be used as desired.

As used herein, an audio stream is played by an electronic device by decoding the audio information encoded into the audio stream, and processing the decoded audio information. The decoded audio information frequently is processed by converting the audio information into sound waves by a speaker, but embodiments may play an audio stream without generating sound waves if desired. For example, in some embodiments an input audio stream may be played by decoding the audio information contained in the input audio stream, manipulating the audio information, and re-encoding the audio information into an output audio stream.

### Audio Hyperlinks

A hyperlink is defined herein as an element in a source audio stream that references a different element in the same audio stream or a different object, designated the destination element. Traversal of a hyperlink is defined as jumping from the source element in the source audio stream to the destination element, and performing the destination element. For example, a hyperlink in an audio stream may indicate a destination of a particular portion of a different audio stream, and traversal of that hyperlink may be performed by jumping to the designated portion of the other audio stream. Depending on the embodiment, the source audio stream may continue to play or may be paused as a result of the traversal of the hyperlink.

In one embodiment, an audio hyperlink indicator is encoded within an audio stream to indicate the presence of a hyperlink. A predetermined audio signal, such as an audio tone or a sequence or pattern of tones, may be used to encode the indicator, followed by audio information that encodes the hyperlink information itself. In one embodiment, the hyperlink may be active only during a certain portion of the audio stream. In one embodiment, the hyperlink indicator may be placed in the audio stream and the hyperlink information containing the reference to the destination element or object is located external to the audio stream and is dynamically associated with the hyperlink indicator by a playback framework. An audio stream may include as many audio hyperlinks as desired.

In one embodiment, the indicator that informs the user of the presence of a hyperlink may be presented or rendered by the by the playback framework or an application at runtime rather than being encoded into the stream. This approach leaves presentation of interface up to the application environment.

The destination element of a hyperlink may, but need not be, audio material. Thus, performing the destination element upon traversal of the hyperlink may vary depending on the type of the destination element. For example, a uniform resource locator encoded in the hyperlink information may cause display of a web page on a display of the electronic device. In another example, traversing the hyperlink may cause the viewing of a video image or stream of video images on the display of the electronic device. In another example, traversing the hyperlink may cause the execution of an application on the electronic device, such as an application to allow a purchase activity. In yet another example, traversing the hyperlink may cause a multimedia content to be performed, including any combination of audio, video, textual, etc, content.

In one embodiment, the hyperlink information may include information specifying one or more of (a) a type of the destination object; (b) an application to use for performing the destination object; and (c) a location of a destination portion of the destination object. Other kinds of information may be included in the hyperlink information as desired.

### Encoding the Hyperlink

Either or both of the hyperlink indicator and hyperlink information may be encoded in the audio stream to be audible to a listener or to be inaudible. In some embodiments, the hyperlink indicator may be an audio tone or sequence of tones that are audible to a listener of the audio stream. In other embodiments, the hyperlink indicator may be an audio tone or sequence of tones that is inaudible to a human listener, such as a tone at a frequency that is outside of the normal hearing range of 20 Hz-20 KHz, but which may be detected and recognized by the electronic device playing the audio stream, causing an effect in a user interface.

In one embodiment, the audio information encoding the hyperlink information may be a pulse at a predetermined frequency or range of frequencies that is inaudible to a listener, such as one that is outside of the range 20 Hz-20 KHz.

In one embodiment, the electronic device may recognize the hyperlink indicator and decode the hyperlink information, then provide some or all of that information to a user through the user interface. The user interface may display information about the hyperlink to a user on a display screen of the electronic device, audibly inform the user of the hyperlink, or take any other user interface action to alert the user to the presence of the hyperlink.

In one embodiment, the hyperlink indicator may be inaudible to the user, but detectable by the electronic device, and the electronic device may select whether or not to traverse the hyperlink by analysis of the hyperlink information, without requesting a decision from a user of the electronic device.

In one embodiment, the hyperlink destination encoded in the hyperlink information may reference a position other than the beginning of an audio or video stream (including a different position in the current audio stream), by providing information to indicate where to begin playing the destination element. The information to indicate the position in the destination element may include timing information (e.g., 6 seconds into the destination audio stream) or spatial information (e.g., 100K bytes into the destination video stream).

In one embodiment, the hyperlink information may be encoded in the audio stream using a varying amplitude audio pulse, such as a fading audio pulse. After the audio pulse changes from an initial predetermined amplitude to a threshold predetermined amplitude, the hyperlink is no longer available for traversal. In another embodiment, the hyperlink information may be encoded in the audio stream using a recognizable audio pulse where termination of the pulse in the audio stream indicates the hyperlink is no longer available. An attempt to traverse the hyperlink when it is no longer available may produce an error indication to the user or may be simply ignored as desired.

In one embodiment, annotations that describe hyperlinks in the audio stream may be provided separately from the audio stream itself, such as in an extension file. At runtime, the playback framework of the electronic device may combine the audio stream with the hyperlinks generated from the annotations. In another embodiment, the annotations may be positioned at the beginning (or some other recognizable position) in the audio stream, instead of at the point of the hyperlink. In such an embodiment, the annotations would include information about the timing or spatial position of the hyperlink in the audio stream. The playback framework would read the annotation information and generate the hyperlinks at the designated time or position during the playback of the audio stream.

### Creation of an Audio Stream Including a Hyperlink

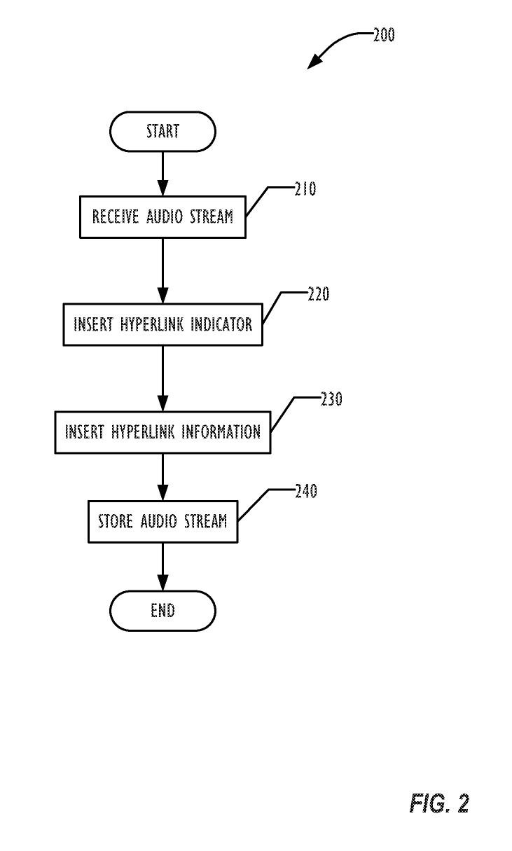

FIG. 2 is a flowchart illustrating a technique 200 for inserting a hyperlink into an audio stream. In block 210, an audio stream is received or created by an electronic device, using any desired technique for receiving or creating an audio stream. At a desired location in the audio stream, a hyperlink indicator is encoded with the audio stream. Hyperlinks may be inserted at locations based on any desired rationale, such as inserting the hyperlink at a point in the audio stream selected based on the content of the audio stream. In one embodiment, the hyperlink indicator is encoded with the audio stream by inserting the hyperlink indicator in metadata of an audio file comprising the audio stream.

In block 230, the hyperlink information may be encoded with the audio stream following the hyperlink indicator forming an annotated audio stream. The hyperlink information designates the destination dement, and if encoded as an audio signal may be encoded into audio signals using any desired encoding technique compatible with the audio stream. The annotated audio stream may then be stored in block 240. In one embodiment, the annotated audio stream is created dynamically by an electronic device that is streaming the audio stream to a recipient, and the complete annotated audio stream may simply be streamed without storing the annotated audio stream.

In one embodiment, a hyperlink information resource external to the audio stream may be created or updated with the hyperlink reference information. The hyperlink information resource may be a the or any other desired technique for making the hyperlink information resource available for later access during playback of the annotated audio stream. Alternately, the hyperlink information resource may be attached to the audio stream at a designated position (e.g., the beginning) of the audios stream. During playback, the hyperlink information resource may be interrogated by the playback framework, and where multiple hyperlink references are contained in the hyperlink information resource, the proper hyperlink reference may be accessed and used for traversal.

Where the annotated audio stream is stored in block 240, the annotated audio stream may be stored as a the on any desired type of media. For example an optical disk may be created containing the annotated audio stream that may be distributed, similar to the distribution of compact discs (CDs) or digital virtual discs (DVDs) today. However, any desired storage media that may contain an audio file may be used, including storage on disc drives of an audio streaming server.

### Playback of an Audio Stream Including a Hyperlink

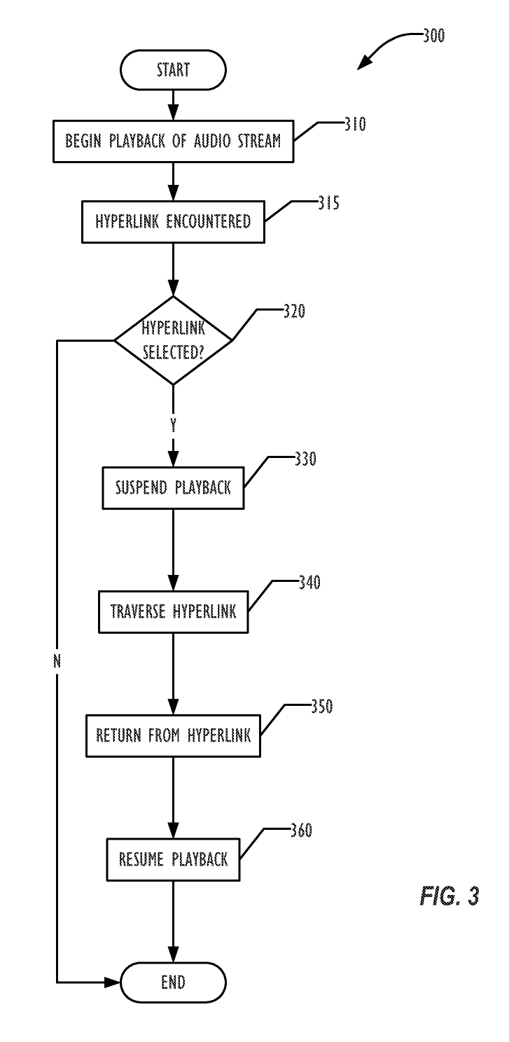

FIG. 3 is a flowchart illustrating a technique 300 for playing an audio stream that includes a hyperlink according to one embodiment. In block 310, playback of the audio stream begins on an electronic device, typically using a playback framework of the electronic device. In block 315, a hyperlink is encountered, either read from metadata associated with the audio stream file or interleaved with the audio data. In block 320, if no hyperlink is selected during playback, playback simply continues to the end of the audio stream. If a hyperlink is selected, however, then in block 330 the playback framework may suspend playback of the audio stream. If the hyperlink points to a non-audio object, audio playback may continue if desired without being suspended, Although FIG. 3 illustrates only a single hyperlink, an audio stream may include multiple hyperlinks and blocks 315-360 may be repeated as many times as hyperlinks are encountered.

Selection of the hyperlink may be performed automatically upon detection of the hyperlink in the audio stream, or may be performed conditionally upon receipt of a request to traverse the hyperlink. In one embodiment, the hyperlink indicator may be recognized by the playback framework of the electronic device and the hyperlink information decoded prior to receipt of a request to traverse the hyperlink.

In block 340, the hyperlink is traversed, causing the destination element to be accessed. For purposes of this discussion, the assumption is made that the destination element is accessible. As is well known in the art, hyperlinks may designate an unreachable destination element, either because the destination element is no longer in existence at that designated location, or because there was an error in the description of the destination element. Any desired or convenient error recovery technique may be employed to handle a situation in which the destination element of a hyperlink is not accessible, including providing an indication to a user of the broken hyperlink. Error recovery techniques are not further discussed herein.

In block 350, control returns from the destination element back to the audio stream. The return may occur automatically at the completion of the access of the destination element, or may be selectively performed by requesting a return to the source element in the audio stream, similar to a user clicking on a back button in a web browser. In the latter scenario, of course, the return may never occur, and instead of suspending playback in block 330, one embodiment may terminate playback, preserving sufficient information to allow playback to continue at the interruption point if later desired.

Upon return to the audio stream, in block 360 playback of the audio stream resumes at the point of the hyperlink and continues to the end or until the next hyperlink is selected.

In one embodiment, instead of suspending the hyperlinked audio stream as the hyperlink is traversed, the hyperlink may cause an action indicated by the hyperlink information to be taken while the original audio stream continues to be played. For example, the hyperlink information may specify that a second audio stream is to be overlaid on top of the original audio stream, combining the audio from the original and second audio streams, and continuing the original audio stream by itself automatically upon completion of the second audio stream. In another example, if the hyperlink information specifies a video stream that is to be displayed, the hyperlink may cause the video stream to be displayed while the original audio stream continues. In a further embodiment, the amplitude of the original audio stream may be decreased during the traversal of the hyperlink, such as where speech in the original audio stream is decreased to a background level underneath a translation of the speech in the hyperlinked audio.

### User Interface

Manipulation of a user interface of the electronic device may allow user control over hyperlinking according to various embodiments. In some embodiments, hyperlink information may be provided by a graphical user interface, with controls to allow the user to indicate whether to traverse the hyperlink, and information to assist the user in deciding whether to traverse the hyperlink.

In other embodiments, user interaction elements such as hardware buttons may be used to control hyperlinking. These user interaction elements may be dedicated to hyperlink controls, or may be overlaid with additional actions to control hyperlink traversal. In one embodiment, a button, such as a button on a headset normally used for accepting a call, may be double-clicked to indicate that a hyperlink should be traversed, and triple-clicked (or single clicked) to indicate a return to the original audio stream. In another embodiment, activation of the call accept button may be combined with activation of the volume increase button to cause the hyperlink to be traversed, and activation of the call accept button combined with activation of the volume decrease button to cause the traversal to be halted and to resume the playback of the original audio stream.

In one embodiment, a user interface may provide controls for hyperlink traversal that are normally not displayed, but are displayed upon activation of another control. For example, on a smartphone, a double-click on a Home button may cause display of the hyperlink user interface.

In yet another embodiment, hyperlink traversal controls may be provided through an audio interface that allows a user of the electronic device to employ voice activation techniques, using voice commands to traverse the hyperlink or to return from the hyperlinked material.

In one embodiment, a chain of hyperlinks may be traversed, so that returning from one hyperlinked destination element may result in the resumption of the predecessor audio stream rather than to the initial audio stream in the chain. In such an embodiment, an additional control or controls may also allow navigation forward in the chain in addition to backward, similar to the back and forward arrows in a web browser.

In one embodiment, a playback framework may provide a list of hyperlinks contained in an audio stream.

### Implementation in an Electronic Device

FIG. 5 is a simplified functional block diagram illustrating an electronic device FIG. 500 according to one embodiment that can implement the techniques described above. The electronic device FIG. 500 may include a processor FIG. 516, display FIG. 520, microphone FIG. 506, audio/video codecs FIG. 502, speaker FIG. 504, communications circuitry FIG. 510, an image sensor with associated camera hardware FIG. 508 for performing image capture, user interface FIG. 518, memory FIG. 512, storage device FIG. 514, and communications bus FIG. 522. Processor FIG. 516 may be any suitable programmable control device and may control the operation of many functions, such as the generation and/or processing of image data, as well as other functions performed by electronic device FIG. 500. Processor FIG. 516 may drive display FIG. 520 and may receive user inputs from the user interface FIG. 518. An embedded processor provides a versatile and robust programmable control device that may be utilized for carrying out the disclosed techniques.

Storage device FIG. 514 may store media (e.g., image and video files), software (e.g., for implementing various functions on device FIG. 500), preference information, device profile information, and any other suitable data. Storage device FIG. 514 may include one more storage mediums for tangibly recording image data and program instructions, including for example, a hard-drive, permanent memory such as ROM, semi-permanent memory such as RAM, or cache. Program instructions may comprise a software implementation encoded in any desired language (e.g., C or C++).

Memory FIG. 512 may include one or more different types of memory which may be used for performing device functions. For example, memory FIG. 512 may include cache, ROM, and/or RAM. Communications bus FIG. 522 may provide a data transfer path for transferring data to, from, or between at least storage device FIG. 514, memory FIG. 512, and processor FIG. 516. Although referred to as a bus, communications bus FIG. 522 is not limited to any specific data transfer technology. User interface FIG. 518 may allow a user to interact with the electronic device FIG. 500. For example, the user interface FIG. 518 can take a variety of forms, such as a button, keypad, dial, a click wheel, or a touch screen.

In one embodiment, the electronic device FIG. 500 may be an electronic device capable of processing and displaying media, such as image and video files. For example, the electronic device FIG. 500 may be a device such as such a mobile phone, personal data assistant (PDA), portable music player, monitor, television, laptop, desktop, and tablet computer, or other suitable personal device.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory computer readable medium, comprising:
computer code to cause an audio stream to playback on an electronic device;
computer code to traverse a hyperlink encoded with the audio stream to a destination object during playback of the audio stream; and
computer code to perform an activity corresponding to the destination object.

2. The non-transitory computer readable medium of claim 1, wherein the destination object comprises at least one of an audio stream, a video stream, a multimedia object, a user application, and a web page.

3. The non-transitory computer readable medium of claim 1, wherein the computer code to traverse a hyperlink encoded with the audio stream to a destination object during playback of the audio stream comprises:
computer code to detect a hyperlink indicator encoded with the audio stream;
computer code to determine the destination object of a hyperlink information associated with the hyperlink indicator; and
computer code to access the destination object.

4. The non-transitory computer readable medium of claim 1, wherein the computer code to traverse a hyperlink encoded with the audio stream to a destination object during playback of the audio stream comprises:
computer code to receive an instruction from a use to traverse the hyperlink.

5. The non-transitory computer readable medium of claim 1, wherein hyperlink information identifies the destination object and one or more of the following: a type of the destination object, an application to invoke to play the destination object, and a location within the destination object.

6. The non-transitory computer readable medium of claim 1, further comprising:
computer code to suspend playback of the audio stream.

7. The non-transitory computer readable medium of claim 6, further comprising:
computer code to resume play of the audio stream upon termination of the destination object.

8. The non-transitory computer readable medium of claim 1, wherein the computer code to traverse a hyperlink encoded with the audio stream to a destination object during playback of the audio stream comprises:
computer code to traverse the hyperlink responsive to a user manipulation of a user interface.

9. A non-transitory computer readable medium, comprising:
computer code to receive a request to insert a hyperlink in an audio stream;
computer code to generate a hyperlink indicator responsive to the request;
computer code to generate a hyperlink information; and
computer code to encode the hyperlink indicator with the audio stream.

10. The non-transitory computer readable medium of claim 9, wherein the computer code to encode the hyperlink indicator with the audio stream stores the hyperlink indicator in metadata associated with an audio file comprising the audio stream.

11. The non-transitory computer readable medium of claim 9, further comprising:
computer code to encode the hyperlink information with the audio stream with the hyperlink indicator.

12. The non-transitory computer readable medium of claim 9, further comprising:
computer code to insert the hyperlink information into a hyperlink information resource external to the audio stream.

13. The non-transitory computer readable medium of claim 12, further comprising:
computer code to attach the hyperlink information resource to the audio stream.

14. The non-transitory computer readable medium of claim 9, further comprising:
computer code to store the audio stream.

15. A non-transitory storage medium on which is stored encoded audio information, wherein the audio information comprises:
a hyperlink indicator that indicates that a hyperlink is encoded with the audio information; and
a hyperlink information element that provides information describing the hyperlink.

16. The non-transitory storage medium of claim 15, wherein the hyperlink indicator is encoded in metadata associated with an audio file.

17. The non-transitory storage medium of claim 15, wherein the hyperlink indicator comprises an encoded audio tone.

18. The non-transitory storage medium of claim 17, wherein the encoded audio tone is audible to a listener during playback of the encoded audio information.

19. The non-transitory storage medium of claim 15, wherein the hyperlink information element comprises an encoded audio pulse.

20. The non-transitory storage medium of claim 19, wherein the encoded audio pulse is inaudible to a listener during playback of the encoded audio information.

21. The non-transitory storage medium of claim 19,
wherein the encoded audio pulse decreases in amplitude over time, and
wherein the hyperlink becomes unavailable upon the amplitude of the encoded audio pulse reaching a predetermined threshold amplitude.

22. The non-transitory storage medium of claim 15, wherein the hyperlink information element describes a hyperlink destination within the encoded audio information.

23. The non-transitory storage medium of claim 15, wherein the hyperlink information element describes a hyperlink destination that is a non-audio resource.

24. An apparatus, comprising:
a programmable control device;
a memory coupled to the programmable control device, wherein instructions are stored in the memory, the instructions causing the programmable control device to:
recognize a hyperlink indicator encoded with an audio stream processed by the programmable control device;
decode a hyperlink information associated with the hyperlink indicator; and
traverse the hyperlink described by the hyperlink information.

25. The apparatus of claim 24, wherein the instructions to cause the programmable control device to traverse the hyperlink comprise instructions cause the programmable device to:
receive a request from a user to traverse the hyperlink; and
traverse the hyperlink responsive to the request.

26. The apparatus of claim 24, wherein the instructions to cause the programmable control device to traverse the hyperlink comprise instructions cause the programmable device to:
suspend playback of the audio stream.

27. The apparatus of claim 24, wherein the hyperlink indicator is a predetermined audible audio signal.

28. The apparatus of claim 24, wherein the hyperlink information comprises:
information identifying a destination object;
information identifying a type of the destination object; and
information identifying an application for performing the destination object.

29. The apparatus of claim 24, wherein the hyperlink information is inaudibly encoded in the audio stream.

30. The apparatus of claim 24, wherein the hyperlink information comprises a variable amplitude audio signal.

31. The apparatus of claim 24, where the instructions stored in the memory further comprise instructions causing the programmable control device to:
present the hyperlink information to a user of the programmable device.

32. A method of inserting an audio hyperlink into an audio stream, comprising:
encoding a hyperlink indicator with the audio stream; and
encoding a hyperlink information with the audio stream with the hyperlink indicator, wherein the hyperlink information provides information for a programmable control device to access a destination object.

33. The method of claim 32, wherein the audio stream comprises an audio file, and the hyperlink indicator and hyperlink information are encoded as metadata associated with the audio file.

34. The method of claim 32, wherein encoding a hyperlink information into the audio stream comprises:
varying an amplitude of the encoded hyperlink information over time.

35. The method of claim 32, wherein encoding a hyperlink information into the audio stream comprises:
encoding the hyperlink information into the audio stream as an inaudible audio pulse detectable by an electronic device playing the audio stream.

36. The method of claim 32, wherein encoding a hyperlink indicator into an audio stream comprises:
encoding the hyperlink indicator as on or more audible tones in the audio stream.

37. A method of using a hyperlink encoded into an audio stream, comprising:
playing the audio stream on an electronic device;
decoding a hyperlink information associated with a hyperlink indicator encoded with the audio stream;
accessing and performing a destination object identified by the hyperlink information;
suspending playing the audio stream upon performing accessing the destination object; and
resuming playing the audio stream upon completion of performing the destination object.

38. The method of claim 37, wherein accessing and performing a destination object is performed responsive to a user request to traverse the hyperlink.

39. The method of claim 37, further comprising:
detecting the hyperlink indicator by the electronic device,
wherein accessing and performing a destination object is performed automatically by the electronic responsive to detecting the hyperlink indicator.
